(19) United States
(12) Patent Application Publication
(10) Pub. No.: US 2025/0068155 A1
(43) Pub. Date: Feb. 27, 2025

(54) Industrial Automation System and Method

(71) Applicant: ABB Schweiz AG, Baden (CH)

(72) Inventors: Sameer Chouksey, Bengaluru (IN); Madapu Amarlingam, Vikarabad (IN); Deepti Maduskar, Bhopal (IN); Divyasheel Sharma, Bangalore (IN); Srijit Kumar, Bangalore (IN)

(73) Assignee: ABB Schweiz AG, Baden (CH)

(21) Appl. No.: 18/944,183

(22) Filed: Nov. 12, 2024

Related U.S. Application Data
(63) Continuation of application No. PCT/EP2022/063087, filed on May 13, 2022.

(51) Int. Cl. G05B 19/418

(52) U.S. Cl. CPC G05B 19/41885

(57) ABSTRACT

An industrial automation system comprises multiple process components, each categorizable into a cohort corresponding to a cohorting criterion. Some process components are configured to perform a machine learning (ML) process. A process component hosts at least a part of an ML model per cohort and communicates the ML model parameters among the multiple process components. The system assigns one or more of the process components to one of the cohorts according to the cohorting criterion; attributes the ML model parameters of a process component in a selected one of the cohorts to the ML model belonging to the selected cohort; determines a proximity value of each pair of cohorts; assigns a pair of cohorts to a respective neighboring cohort group when the proximity value meets a predetermined proximity criterion; and shares the ML model related data between process components belonging to the same neighboring cohort group.

### CROSS-REFERENCE TO RELATED APPLICATIONS

The instant application claims priority to International Patent Application No. PCT/EP2022/063087, filed May 13, 2022, which is incorporated herein in its entirety by reference.

### FIELD OF THE DISCLOSURE

The present disclosure relates to an industrial automation system for implementing at least one industrial process. It further relates to a computer-implemented method performed in an industrial automation system.

### BACKGROUND OF THE INVENTION

In industrial automation, it is often desired to detect anomalies, predict the need for maintenance etc. of a plant that the industrial automation is applied to. Some industrial automation solutions make use of machine learning (ML) techniques, such as ML based soft sensors. ML relies on robust training of a corresponding ML model. For training, enough data that captures different scenarios in the plant, and sufficient data for each scenario, are needed.

When training an ML model, data, such as local data, have to be accessible. An industrial site may include multiple plants each carrying out a process. Plants may also be spread across multiple industrial sites. In a conventional example, an ML model is trained on-plant or on-site, i.e. within an area of a plant or a site where data are readily present and accessible. In this case, training the ML model is performed using plant-local data or site-local data only, which may not be sufficient for developing a robust ML model.

As a non-limiting example, in the process automation of a cement plant, machine learning (ML) based soft sensors are used e.g. for detecting anomalies, predict attributes related to maintenance work etc. It is desired that any ML model used in these exemplary ML based technologies is a robust ML model. Robustness is achieved, for example, by training the ML model using captured data of different scenarios and/or using a sufficient amount of those data.

A typical way of training an ML model is training it at the site of the industrial process (on-site, on-premise). For example, the ML model is trained on-premise on edge/server IT infrastructure using local data. In this case, learning the ML model is restricted to the local data. Local data may not sufficient in order for the ML model to become robust. It is also possible to share data from multiple sites of the same or different industrial processes, e.g. in order to achieve and/or improve robustness of the ML model. For example, data from multiple plants may be shared with a server, such as a central server that may be cloud-hosted. In this case, sensitive data may be involved, which is not desired and/or not allowed to be shared, or compromised, across the site boundaries. Moreover, sharing the data for training an ML model typically involves large amounts of data to be communicated, which increases the communication overhead, storage cost and power consumption. There is a need for enhancing ML model quality.

### BRIEF SUMMARY OF THE INVENTION

According to an aspect, an industrial automation system for implementing at least one industrial process is provided. The industrial automation system includes multiple process components. Each process component is categorizable into a cohort corresponding to a cohorting criterion. At least some of the process components are configured to perform an ML process involving ML model parameters. At least one of the process components is configured to host at least a part of at least one ML model per cohort. The at least one process components is further configured to communicate the ML model parameters among the multiple process components. The system is configured to assign one or more of the process components to one of the cohorts according to the cohorting criterion; attribute the ML model parameters of a process component in a selected one of the cohorts to the ML model belonging to the selected cohort; determine a proximity value of each pair of cohorts; assign a pair of cohorts to a respective neighboring cohort group if the proximity value meets a predetermined proximity criterion; and share the ML model related data between process components belonging to the same neighboring cohort group.

According to a further aspect, a computer-implemented method performed in an industrial automation system for implementing at least one industrial process is provided. The industrial automation system includes multiple process components. Each process component is categorizable into a cohort corresponding to a cohorting criterion. In the method, on one of the process components, an ML process involving model parameters is performed. On the same or another one of the process components of the system, at least a part of at least one ML model per cohort is hosted. The ML model parameters are communicated among the multiple process components. One or more of the process components are assigned, typically automatically assigned, to one of the cohorts according to the cohorting criterion. The ML model parameters of the process components in a selected one of the cohorts are attributed, typically automatically attributed, to the ML model belonging to the selected cohort.

According to yet a further aspect, a non-volatile storage medium is provided. The storage medium has a computer program stored thereon. The computer program includes instructions that, when they are executed on a processor of an industrial automation system, cause the processor to perform a method as described herein.

### BRIEF DESCRIPTION OF THE SEVERAL VIEWS OF THE DRAWING(S)

FIG. 1 is a schematic diagram of an industrial automation system according to an embodiment of the present disclosure.

FIG. 2 is a schematic diagram of an industrial automation system according to an embodiment of the present disclosure.

FIG. 3 is a schematic example of a collaborative learning environment with cohorts in accordance with the disclosure.

FIG. 4 is a schematic example of a cascaded filter in accordance with the disclosure.

FIG. 5 is a schematic example of cohort-neighborhood based learning arrangement in accordance with the disclosure.

FIG. 6 is a procedural flowchart of a method according to an embodiment of the present disclosure.

FIG. 7 is a procedural flowchart of a part of a method according to an embodiment of the present disclosure.

### DETAILED DESCRIPTION OF THE INVENTION

It is believed that the various features described within this disclosure will be better understood from a consideration of the description in conjunction with the drawings. The processes, systems, methods etc. and any variations thereof described herein are provided for the purpose of illustration, and shall be construed as a representative basis for teaching a person skilled in the art to employ the features described herein, including variation thereof.

This disclosure relates to techniques employed in connection with automating an industrial process using an industrial automation system. Collaborative learning (CL) in industrial automation refers to a technique in which multiple process components collaborate in training a machine learning (ML) model. Each process component is involved in the industrial automation, e.g. contributes to an automated process such as, without limitation, producing cement or other industrial goods. Typically, in CL, the process components include multiple clients and at least one server, wherein the server hosts one or more ML models; however, it is conceivable that some or all process components host at least a part of one or more ML models in a peer-to-peer like configuration. For the case of explanation, and without any intention to be conceived as limiting, key concepts of CL are described in the context of a client-server model, rather than a peer-to-peer model.

In a typical CL framework, each client's raw data, such as measurement data, process data etc., are stored locally and not exchanged or transferred across site boundaries (e.g., plant boundaries). Instead, focused ML model updates intended for immediate aggregation are shared with a server, such as a central server, to achieve the objective of collaborative model learning.

However, CL may be challenging in certain circumstances. In order to collaborate in the CL, the raw data have to be transferred to the (central) server. Security risks, such as corrupted data integrity, unintended proliferation of data etc., and/or expensive IT challenges such as a high overhead for encryption and data transfer etc., may arise when the raw data are transferred to the server. This is particularly the case when dealing with multiple plants spread across different industrial sites. Other kinds of challenges may arise from the fact that multiple plants on different sites may have underlying differences in their data and its distributions, processes, environmental and operational conditions etc.

Federated learning (FL) is a machine learning technique that trains an algorithm across multiple decentralized edge devices or servers holding local data samples, without exchanging them. FL enables multiple process components to build a common ML model without sharing raw data.

FIG. 1 illustrates a schematic diagram of an industrial automation system 100 according to an embodiment. The industrial automation system 100 includes process components 200, 301, 302, 303, 304. In the example of FIG. 1, process component 200 is configured as a server, such as a centralized server, and process components 301, 302, 303, 304 are each configured as a client. Each client 301, 302, 303, 304 is connected to the server 200 via a corresponding data connection 311, 312, 313, 314 for transmitting, receiving and/or exchanging data. The data connections 311, 312, 313, 314 include, without limitation, a wired or a wireless data connection, such as a bus system like CANBUS, an Ethernet connection etc. Server 200 hosts machine learning model M1 and machine learning model M2. In FIG. 1, some or all of clients 301, 302, 303, 304 perform an ML process involving model parameters and communicate some or all ML model parameters with the server 200.

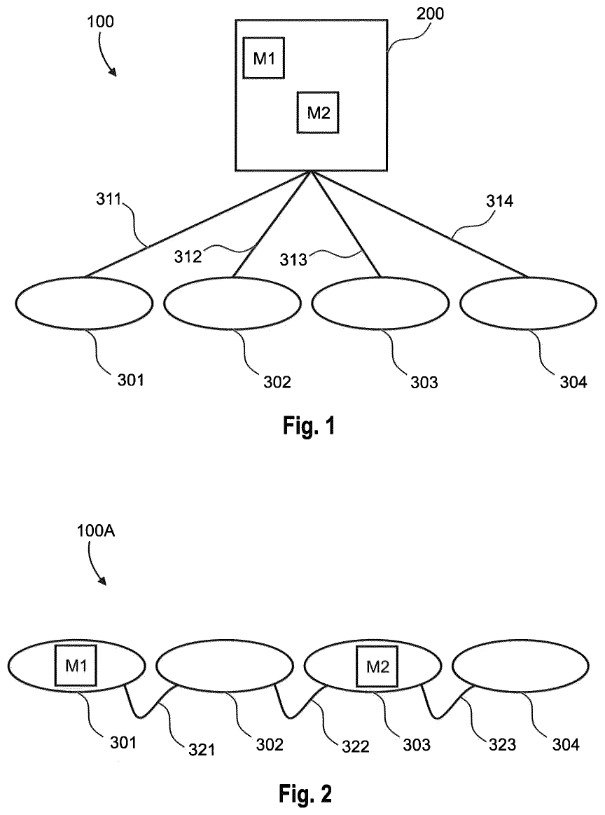

FIG. 2 illustrates a schematic diagram of an industrial automation system 100A according to another embodiment. The industrial automation system 100 includes process components 301, 302, 303, 304. In the example of FIG. 1, the process components 301, 302, 303, 304 are connected with each other via data connections 321, 322, 323 for transmitting, receiving and/or exchanging data. Data connections 321, 322, 323 are not limited to the topography as shown in FIG. 2, and may include direct and/or indirect connections between any of the process components 301, 302, 303, 304. The data connections 321, 322, 323 include, without limitation, a wired or a wireless data connection, such as a bus system like CANBUS, an Ethernet connection etc. In the example of FIG. 2, no central server 200 is provided; instead, some process components or each process component 301, 302, 303, 304 hosts at least a part of machine learning model M1 and/or machine learning model M2. In the non-limiting example of FIG. 2, process component 301 hosts ML model M1, and process component 303 hosts ML model M2. In FIG. 2, some or all of process components 301, 302, 303, 304 perform an ML process involving model parameters and communicate some or all ML model parameters with some or all other process components 301, 302, 303, 304.

It is understood that the configurations of industrial automation systems 100, 100A are merely examples, and that further configurations and/or topographies may be employed, such as a combination of some features of industrial automation systems 100, 100A or an omission of some features, as long as at least one of the process components 301, 302, 303, 304 is configured to perform an ML process involving ML model parameters, and at least one of process components 301, 302, 303, 304 is configured to host at least a part of at least one ML model and communicate the ML model parameters among the multiple process components 301, 302, 303, 304.

The following description applies to both the industrial automation system 100 of FIG. 1 and the industrial automation system 100A of FIG. 2, except when stated otherwise.

In the industrial process automation system 100, 100A, some or all of process components 301, 302, 303, 304 are configured to perform an ML process, such as an FL process. In the ML process, ML model parameters are derived from transforming raw data from the process components, such as e.g. measurement data, process data etc., into the ML model by training the ML model. Furthermore, in the industrial process automation system 100, 100A, some or all of process components 301, 302, 303, 304 are configured to host at least a part of at least one ML model, and to communicate the ML model parameters belonging to the hosted model among the process components 301, 302, 303, 304.

The process components 301, 302, 303, 304 are each categorizable into a cohort corresponding to a cohorting criterion, i.e. a principle by which the process components 301, 302, 303, 304 are assigned, or attributed, a certain cohort. The ML models M1, M2 can be considered per-cohort common models. For example, in the client-server approach of FIG. 1, the server 200 hosts a common model M1 and a common model M2, and the clients 301, 302, 303, 304 run local models communicated (e.g. broadcasted) by the server 200 and according to their respective cohort. In the peer-to-peer approach of FIG. 2, process component 301 hosts a common model M1 and process component 303 hosts a common model M2, and the process components 301, 302, 303, 304 run local models communicated among the process components 301, 302, 303, 304 and according to their respective cohort.

In either case, a typical workflow iteration may be as follows: A common model M1, M2, is communicated among the process components 301, 302, 303, 304; an anomaly prediction is carried out locally on the process component(s) 301, 302, 303, 304 running the model M1, M2; a retraining is carried out locally on the process component(s) 301, 302, 303, 304 running the model M1, M2; the retrained model is sent back to the server 200 or a peer process component 301, 302, 303, 304; the server 200 or the peer process component 301, 302, 303, 304 carries out an accuracy and model aggregation; the aggregated model is communicated among the process components 301, 302, 303, 304; and the next iteration begins. In other words, in the exemplary client-server model of FIG. 1, initially server 200 sends the global consensus model to the clients, for example an ML model for anomaly prediction. The client 301, 302, 303, 304 receives the model from server 200 and retrains the model using local data. Then the client shares the updated model weights to the server 200. These tasks in combination may be referred to as a communication round or an iteration.

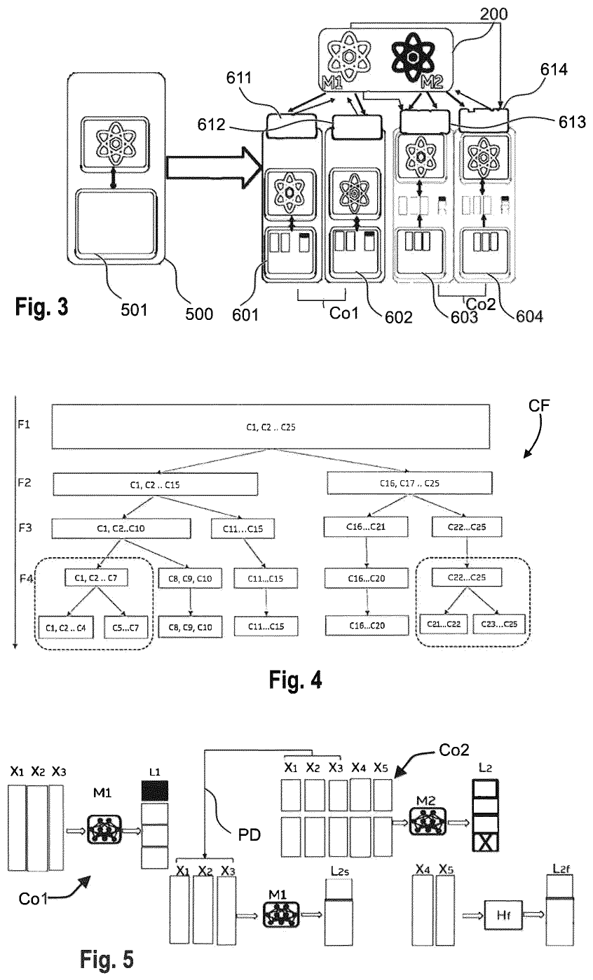

FIG. 3 illustrates a schematic example of a collaborative learning environment with cohorts. A cement plant 500 includes lab data 501 which is sent to multiple plants 601, 602, 603, and 604. Each plant 601, 602, 603, 604 communicates, via a respective CL enabler 611, 612, 613, 614, with a server 200. The server 200 hosts ML model M1 and ML model M2. Plant 601 and plant 602 are categorized into a same cohort Co1. Plant 603 and plant 604 are categorized into a same cohort Co2. Plant 601 hosts 600 items of lab data. Plant 602 hosts 500 items of lab data. Plant 603 hosts 200 items of lab data. Plant 604 hosts 300 items of lab data. Cohort C1 is thus considered a strong cohort. Cohort Co2 is considered a weak cohort. Inter-cohort Co1, Co2 knowledge, i.e. domain knowledge, like a type of fuel, cement, and/or production process, contributes to the cohorting.

CL enabler 611, 612, 613, 614 performs one or more of a cohort attribute collection, a model validation, a communication, a model adaptation, an optimized retraining. In the cohort attribute collection, attributes for cohorting are collected from the plant nodes 601, 602, 603, 604. In the model validation, new global models are validated before replacing an existing local model. In the communication, a communication protocol is adapted, such as, without limitation, gRPC or OPC UA. In the model adaptation, an adaptation to the underlying ML model is performed. In the optimized retraining, a frequency of retraining is optimized based on parameters such as the data sampling frequency.

CL enabler 611, 612, 613, 614 helps to segregate the plants 601, 602, 603, 604 into different clusters (or cohorts) based on different parameters such as environmental conditions or operating conditions, type of task, etc. Non-limiting examples of attributes that can be considered for cohorting include the task (e.g. the purpose of ML based soft sensors running in the plant), environmental/operational conditions, attributes of data recorded by the plant, and data distribution in different plants (like mean value, variable, skew, kurtosis, etc.). CL enabler 611, 612, 613, 614 collects these attributes from the plants 601, 602, 603, 604 and communicates to the process components 200, 301, 302, 303, and 304, for cohorting.

FIG. 4 illustrates a schematic example of a cascaded filter CF for performing a cohorting operation. Cohorting may include segregating the nodes (plants 601, 602, 603, 604; process components 301, 302, 303, 304) into cohorts, and finding neighboring cohorts for each cohort. In FIG. 4, the cascaded filter CF includes filters on filter stages F1, F2, F3, F4. Output from the filter in filter stage F1 are input into the filters in filter stage F2. Output from the filters in filter stage F2 are input into the filters in filter stage F3. Output from the filters in filter stage F3 are input into the filters in filter stage F4. F4 is the final filter stage. Process components in FIG. 4 are represented by clients C1 through C25. Filters in cascaded filter CF are different attributes, examples of which are given below. Based on the filter attributes the clients C1 . . . . C25 get divided into cohorts. Filter stage F4 shows the cohorts as outputs. A neighboring cohorts is defined as a cohort that differs with final filter. For example clients C1, C2, C3, C4 belong to cohort 1 and C5, C6, C7 belong to cohort 2 and they are neighboring cohorts and they are different with respect to filter F4. The process components 301, 302, 303, 304 belonging to a cohort contribute to one ML model M1, M2.

As an example related to cement industry, the following filters can be considered to group various cement plants:
F1: Soft sensor for cyclone blockage detection;
F2: Type of cement being produced;
F3: Type of the fuel used in plant;
F4: Data distribution of parameters such as fuel, fuel consumption, pressure, and temperature.

FIG. 5 illustrates a schematic example of cohort-neighborhood based learning for explaining a cohort-neighborhood learning method for improving the model accuracy of poorly performing cohorts. For example, consider cohort Co1 is training the model M1 and cohort Co2 is training model M2 and they are neighbors, i.e. neighboring cohorts. The data and features available at cohort Co1, Xa=[x1 x2 x3] and corresponding target set L1. Cohort Co2 has the data with features Xb=[x1 x2 x3 x4 x5] and has either no targets or noisy or incomplete targets. We can train the model M2 with the support of model M1 of cohort Co1. As feature space of cohort Co1 is a subset of cohort Co2, ML model M1 is utilized for getting partial soft targets L2s by sending Xbs=[x1 x2 x3] as input. The heuristic function is determined depending on domain knowledge, here as an example: Hf, to derive the partial soft targets using the feature set [x4, x5], i.e., L2f=Hf(x4,x5). Hf is the alkali to Sulphur ratio, and x4 represents alkali, and x5 represents sulfur. A combining function F (L2s, L2f) such as weighted sum, W1*L2s+W2*L2f, is used for getting the complete set of soft targets for cohort Co2, i.e., L2=W1*L2s+W2*L2f. Now, model M2 is trained using the feature set Xb and soft targets L2. In the cement plant example, M1 may be a machine learning model for cyclone blockage prediction build using the parameters x1 as the fuel type, x2 as the fuel consumption, and x3 as the kiln oxygen.

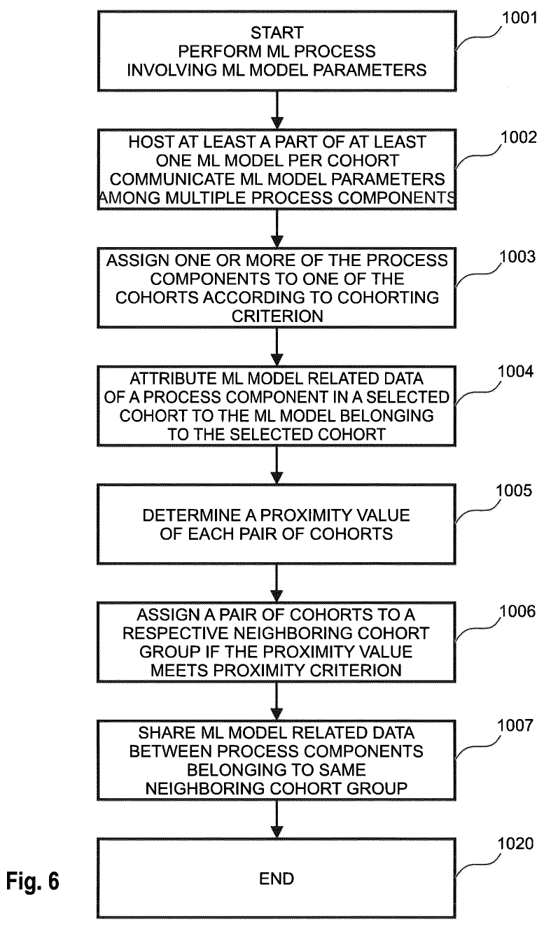

FIG. 6 illustrates a procedural flowchart of a method according to an embodiment, which starts in 1001. In 1001, on one of the one of the process components of the system, an ML process is performed that involves ML model parameters. In 1002, on the same or another one of the process components of the system, at least a part of at least one ML model per cohort is hosted, and the ML model parameters are communicated among the multiple process components. In 1003, one or more of the process components are assigned, typically automatically assigned, to one of the cohorts according to the cohorting criterion. In 1004, the ML model parameters of a process component in a selected one of the cohorts are attributed, typically automatically attributed, to the ML model belonging to the selected cohort. In 1005, a proximity value of each pair of cohorts is determined, typically automatically determined. In 1006, a pair of cohorts is assigned, typically automatically assigned, to a respective neighboring cohort group if the proximity value meets a predetermined proximity criterion. In 1007, the ML model related data are shared, typically automatically shared, between process components belonging to the same neighboring cohort group.

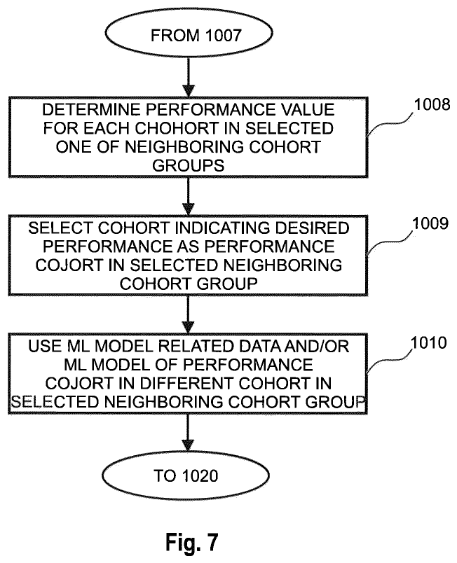

FIG. 7 illustrates a variation, or supplement, to the method of FIG. 6 in a supplementary procedural flowchart. In 1008, a performance value for each cohort in a selected one of the neighboring cohort groups is determined, typically automatically determined. In 1009, based on the performance value, the cohort indicating a desired performance as a performance cohort in the selected neighboring cohort group is selected, typically automatically selected. In 1010, the ML model related data and/or the ML model of the performance cohort is used in at least one different cohort in the selected neighboring cohort group.

By employing the techniques as described herein, beneficially, common CL/FL issues such as limited data availability and localized learning is addressed. Thus, robust predictions and improved productivity can be achieved. Furthermore, by employing the techniques as described herein, beneficially, no possibly sensitive data leaves the premises, such that data related services may be more widely accepted by an operating entity of a plant. Furthermore, by employing the techniques as described herein, beneficially, the technology described herein is sustainable, which may make a transfer of the model learnings to a new plant easier. Furthermore, by employing the techniques as described herein, beneficially, the engineering efforts are reduced. Furthermore, by employing the techniques as described herein, beneficially, the solution is scalable, as the solution can be used across multiple plants with minimal changes.

The expert engages continuously with the operator, which leads to a continuous service opportunity for other MPC performance monitoring and improvement as well as additional MPC implementation.

The description of the inventive arrangements provided herein is for purposes of illustration and is not intended to be exhaustive or limited to the form and examples disclosed. The terminology used herein was chosen to explain the principles of the inventive arrangements, the practical application or technical improvement over technologies found in the marketplace, and/or to enable others of ordinary skill in the art to understand the inventive arrangements disclosed herein. Modifications and variations may be apparent to those of ordinary skill in the art without departing from the scope and spirit of the described inventive arrangements. Accordingly, reference should be made to the following claims, rather than to the foregoing disclosure, as indicating the scope of such features and implementations.

The following examples, features, and details may be considered and/or applied to any one or more of the industrial automation system as described herein, the computer-implemented method as described herein, the non-volatile storage medium as described herein.

A process component, as used herein, is a means or device involved in performing a process belonging to the industrial automation application that the industrial automation system is used in. For example, a process is an automated process such as an automated production of a chemical substance, a technical device etc. Typically, each process component performs a certain physical, chemical, technical or virtual function in the automated process.

Typically, two or more of the process components host at least a part of at least one ML model per cohort. For example, one process component hosts a full ML model for the cohort that the process component belongs to, e.g. is categorized/assigned to. Another process component, belonging to a different cohort, for example hosts another full ML model for this cohort.

A cohort, as used herein, is a group of process components that share a predetermined characteristic. Typically, process components of a same cohort perform a same or comparable physical, chemical, technical or virtual function in the automated process. As an example, and without limitation, when considering a cross-site or cross-plant industrial automation system, a first process component of a first site or a first plant performs a same or a comparable function as a second process component of a second site or a second plant; the first and second process components may share a same cohort.

That is, different process components may be part of the same cohort. For example, process components contributing to comparable processes on different sites may be part of a same cohort, i.e. categorized to be in a same cohort.

A cohorting criterion, as used herein, is a principle by which the process components are assigned, or attributed, a certain cohort. For example, and without limitation, the cohorting criterion may be a judgment whether two process components perform a same or a comparable function, and based on the judgment, assigning the two process components a same cohort when it is judged that the two process components perform the same or comparable function.

Assigning one or more of the process components to one of the cohorts according to the cohorting criterion may, consequently, include judging whether two process components perform a same or a comparable function, and based on the judgment, assigning the two process components a same cohort when it is judged that the two process components perform the same or comparable function.

Attributing the ML model parameters of a process component in a selected one of the cohorts to the ML model belonging to the selected cohort may include providing, to a process component in the selected one of the cohorts that lacks an ML model and/or that is scarce of data for performing a ML operation on its own, the ML model parameters of a process component in the same selected one of the cohorts which has a sufficient ML model.

A proximity value, as used herein, is a measure, or degree, indicating an alikeness of the functions of process components in one cohort to the functions of process components in another cohort. A proximity criterion, as used herein, is e.g. a mathematical operation allowing the proximity value to be determined. For example, when process components for which it is, from a ML perspective, not justified to share a same cohort but their functions are still sufficiently alike, they may have a proximity value indicating this sufficient alikeness.

Sharing the ML model related data between process components belonging to the same neighboring cohort group typically includes a communication of the ML model related data from one process component to another. The communication may include any suitable form of data transmission and/or data reception, such as a wired or a wireless data communication.

In an example, the techniques described herein further include determining a performance value for each cohort in a selected one of the neighboring cohort groups; based on the performance value, selecting the cohort indicating a desired performance as a performance cohort in the selected neighboring cohort group; and using the ML model related data and/or the ML model of the performance cohort in at least one different cohort in the selected neighboring cohort group.

A selected one of the neighboring cohort groups, as used herein, may be determined by choosing one of the neighboring cohort groups for the selection.

A performance value, as used herein, may be a measure, or degree, of how the process components in the respective cohort perform in their respective function(s), such as physical, chemical, technical, or virtual function(s). As a non-limiting example, a performance value may include an actual output of an intermediate product in a function (a sub-process), an actual control deviation of a function (a sub-process), and the like. A desired performance, as used herein, may be a measure, or degree, of how the process components in the respective cohort should perform in their respective function(s), such as physical, chemical, technical, or virtual function(s). Further to the non-limiting example above, a desired performance may include a nominal output of an intermediate product in a function (a sub-process), a nominal control deviation of a function (a sub-process), and the like. A relation of the performance value to the desired performance may indicate how well the process components in the respective cohort actually perform.

A performance cohort, as used herein, may indicate that a cohort meets a desired performance. For example, some or all of the process components included in the performance cohort work sufficiently well to carry out their function (the sub-process) as desired or predetermined.

In an example, the cohorting criterion is defined as a cascade of staged filters. Each filter is configured to assign each process component a filter output group according to one or more component attributes, as an output of the respective filter stage.

A cascade of staged filters, as used herein, refers to a succession of filters in which an output of a filter belonging to a first filter stage is input to a filter belonging to a second filter stage, wherein the second filter stage is a successor of the first filter stage. This cascade, however, is not limited to two filter stages, and may include more than two filter stages, such as three, four or more.

A filter output group, as used herein, refers to the distinction that a filter in the cascade of staged filters actually makes. That is, the filter output group typically includes a classification performed by the respective filter.

A component attribute, as used herein, refers to a characteristic, or quality, of the component under consideration. As far as the filter assigns each process component a filter output group according to one or more component attributes, it effectively characterizes the component (e.g. according to its quality).

In an example further relating to the cascade of staged filters, the techniques described herein further include assigning all process components that leave the last filter stage in the same filter output group to the same respective cohort.

In an example, the proximity criterion to assign a pair of cohorts to a respective neighboring cohort group is met when a process component leaves the penultimate filter stage in the same filter output group but leaves the last filter stage in a different filter output group.

In an example, the techniques described herein are applied to industrial automation involving a cement plant or multiple cement plants. For example, the industrial automation system includes one or more cement plants, i.e. the industrial automation system is involved in controlling one or more cement plants. In the case of multiple cement plants, it is for example possible to have multiple per-plant industrial automation systems, such as—without limitation—multiple on-site industrial automation systems per each plant; and a superordinate system that accounts for or implements any interrelation between the per-plant industrial automation systems necessary for carrying out the technology described herein.

In an example relating to the cement plant or cement plants, the component attributes include one or more of a cyclone blockage detector, a type of cement produced in the plant or the plants, a type of fuel used in the plant or the plants, a data distribution of plant parameters including one or more of a fuel consumption, a pressure, and a temperature.

In an example relating to the component attributes just described, the cyclone blockage detector is included in a first filter stage of the cascade of staged filters, the type of cement produced in the plant or the plants is included in a second filter stage of the cascade of staged filters, the type of fuel used in the plant or the plants is included in a third filter stage of the cascade of staged filters, and the data distribution of plant parameters is included in a fourth filter stage of the cascade of staged filters.

In an example relating to the component attributes just described, wherein the fourth filter stage is the last filter stage and/or the third filter stage is the penultimate filter stage.

In an example, at least one of the process components that hosts an ML model per a respective cohort is configured as a server communicating the ML model parameters to at least some of the other process components as clients.

In an example, provided is a group of cement plants including the industrial automation system described herein. The process components are distributed over different cement plants in the group.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An industrial automation system for implementing at least one industrial process, the industrial automation system comprising multiple process components, each of the multiple process components being categorizable into a cohort corresponding to a cohorting criterion, wherein:
at least some of the multiple process components are configured to perform a machine learning (ML) process involving ML model parameters; and
at least one of the process components is configured to host at least a part of at least one ML model per cohort and is further configured to communicate the ML model parameters among the multiple process components;
wherein the system is configured to:
assign one or more of the process components to one of the cohorts according to the cohorting criterion;
attribute the ML model parameters of a process component in a selected one of the cohorts to the ML model belonging to the selected cohort;
determine a proximity value of each pair of cohorts;
assign a pair of cohorts to a respective neighboring cohort group if the proximity value meets a predetermined proximity criterion; and
share ML model related data between process components belonging to the same neighboring cohort group.

2. The industrial automation system of claim 1, wherein the system is further configured to:
determine a performance value for each cohort in a selected one of the neighboring cohort groups;
based on the performance value, select the cohort indicating a desired performance as a performance cohort in the selected neighboring cohort group; and
use the ML model related data and/or the ML model of the performance cohort in at least one different cohort in the selected neighboring cohort group.

3. The industrial automation system of claim 1, wherein the cohorting criterion is defined as a cascade of staged filters, wherein each of the cascade of staged filters is configured to assign each process component a filter output group according to one or more component attributes as an output of the respective cascade staged filter.

4. The industrial automation system of claim 3, wherein the system is further configured to assign all process components that leave a last one of the cascade filter stages in a same filter output group to the same respective cohort.

5. The industrial automation system of claim 3, wherein the proximity criterion to assign a pair of cohorts to a respective neighboring cohort group is met when a process component leaves a penultimate cascade staged filter in the same filter output group but leaves the last cascade staged filter in a different filter output group.

6. The industrial automation system of claim 1, wherein the industrial automation system includes one or more cement plants.

7. The industrial automation system of claim 3, wherein the industrial automation system includes one or more cement plants, and wherein the component attributes include one or more of a cyclone blockage detector, a type of cement produced in the plant or the plants, a type of fuel used in the plant or the plants, a data distribution of plant parameters including one or more of a fuel consumption, a pressure, and a temperature.

8. The industrial automation system of claim 7, wherein the cyclone blockage detector is included in a first filter stage of the cascade of staged filters, the type of cement produced in the plant or the plants is included in a second filter stage of the cascade of staged filters, the type of fuel used in the plant or the plants is included in a third filter stage of the cascade of staged filters, and the data distribution of plant parameters is included in a fourth filter stage of the cascade of staged filters.

9. The industrial automation system of claim 8, wherein the fourth filter stage is a last filter stage and/or wherein the third filter stage is a penultimate filter stage.

10. The industrial automation system of claim 1, wherein at least one of the process components that hosts an ML model per a respective cohort is configured as a server communicating the ML model parameters to at least some of the other process components as clients.

11. A group of cement plants including an industrial automation system for implementing at least one industrial process, the industrial automation system comprising multiple process components each categorizable into a cohort corresponding to a cohorting criterion, wherein:
at least some of the process components are configured to perform a machine learning (ML) process involving ML model parameters; and
at least one of the process components is configured to host at least a part of at least one ML model per cohort and is further configured to communicate the ML model parameters among the multiple process components;
wherein the system is configured to:
assign one or more of the process components to one of the cohorts according to the cohorting criterion;
attribute the ML model parameters of a process component in a selected one of the cohorts to the ML model belonging to the selected cohort;
determine a proximity value of each pair of cohorts;
assign a pair of cohorts to a respective neighboring cohort group if the proximity value meets a predetermined proximity criterion; and
share ML model related data between process components belonging to the same neighboring cohort group,
wherein the process components are distributed over different cement plants in the group.

12. A computer-implemented method performed in an industrial automation system for implementing at least one industrial process, the industrial automation system comprising multiple process components each categorizable into a cohort corresponding to a cohorting criterion, the method comprising:
on one of the process components of the system, performing a machine learning (ML) process involving ML model parameters; and
on the same or another one of the process components of the system, hosting at least a part of at least one ML model per cohort, and communicating the ML model parameters among the multiple process components;
automatically assigning one or more of the process components to one of the cohorts according to the cohorting criterion;
automatically attributing the ML model parameters of a process component in a selected one of the cohorts to the ML model belonging to the selected cohort;
automatically determining a proximity value of each pair of cohorts;
automatically assigning a pair of cohorts to a respective neighboring cohort group if the proximity value meets a predetermined proximity criterion; and
automatically sharing ML model related data between process components belonging to the same neighboring cohort group.

13. The method of claim 12, further comprising:
automatically determining a performance value for each cohort in a selected one of the neighboring cohort groups;
based on the performance value, automatically selecting the cohort indicating a desired performance as a performance cohort in the selected neighboring cohort group; and
using the ML model related data and/or the ML model of the performance cohort in at least one different cohort in the selected neighboring cohort group.

14. The method of claim 12, further comprising applying filters in a cascade of staged filters that implement the cohorting criterion to the process components, wherein each filter, as an output of the respective filter stage, assigns each process component a filter output group according to one or more component attributes.

15. The method of claim 14, further comprising assigning all process components that leave the last filter stage in the same filter output group to the same respective cohort.

16. The method of claim 14, further comprising assigning a pair of cohorts to a respective neighboring cohort when a process component leaves the penultimate filter stage in the same filter output group but leaves the last filter stage in a different filter output group.

17. The method of claim 12, wherein the proximity criterion to assign a pair of cohorts to a respective neighboring cohort group is met when a process component leaves the penultimate filter stage in the same filter output group but leaves the last filter stage in a different filter output group.

18. A non-volatile storage medium having a computer program stored thereon, the computer program including instructions that, when executed on a processor of an industrial automation system for implementing at least one industrial process, cause the processor to perform a method, the industrial automation system comprising multiple process components each categorizable into a cohort corresponding to a cohorting criterion, the method comprising:
on one of the process components of the system, performing a machine learning, ML, process, involving ML model parameters; and
on the same or another one of the process components of the system, hosting at least a part of at least one ML model per cohort, and communicating the ML model parameters among the multiple process components;
automatically assigning one or more of the process components to one of the cohorts according to the cohorting criterion;
automatically attributing the ML model parameters of a process component in a selected one of the cohorts to the ML model belonging to the selected cohort;
automatically determining a proximity value of each pair of cohorts;
automatically assigning a pair of cohorts to a respective neighboring cohort group if the proximity value meets a predetermined proximity criterion; and
automatically sharing ML model related data between process components belonging to the same neighboring cohort group.
